(19) United States
(12) Patent Application Publication
(10) Pub. No.: US 2016/0141694 A1
(43) Pub. Date: May 19, 2016

(54) CATHODES CAPABLE OF OPERATING IN AN ELECTROCHEMICAL REACTION, AND RELATED CELLS, DEVICES, AND METHODS

(71) Applicant: GENERAL ELECTRIC COMPANY, Schenectady, NY (US)

(72) Inventors: Grigorii Lev SOLOVEICHIK, Niskayuna, NY (US); Sergei KNIAJANSKI, Niskayuna, NY (US); Guillermo Daniel ZAPPI, Niskayuna, NY (US)

(21) Appl. No.: 14/896,525

(22) PCT Filed: Jun. 6, 2014
(86) PCT No.: PCT/US14/41374

§ 371 Date: Dec. 7, 2015

Related U.S. Application Data
(60) Provisional application No. 61/832,236, filed on Jun. 7, 2013.
(60) Provisional application No. 61/832,221, filed on Jun. 7, 2013.

(51) Int. Cl. H01M 8/08; H01M 8/20; H01M 8/18

(52) U.S. Cl. CPC H01M 8/08; H01M 8/188; H01M 8/20; H01M 2250/20; H01M 2250/10; H01M 2300/0005

(57) ABSTRACT

A flow battery is described, including a catholyte in the form of an aqueous solution of at least one salt of a halogen oxoacid compound; and an anolyte that includes an eletrochemically-active material capable of participating in a reduction-oxidation (redox) reaction with the catholyte salt; along with an intervening ion-permeable membrane. A unique cathode used in the battery or for other purposes is also described, along with a method of providing electrical energy to a device, system, or vehicle, using the flow battery.

### CROSS REFERENCE TO RELATED PATENT APPLICATIONS

This application is a national stage application under 35 U.S.C. §371(c) of prior filed, co-pending PCT application serial number PCT/US2014/041374, filed on Jun. 6, 2014, which claims priority to U.S. Provisional Applications Ser. No. 61/832,236 (G. Soloveichik et al), filed on Jun. 7, 2013; and Ser. No. 61/832,221 (G. Soloveichik), filed on Jun. 7, 2013. The contents of both of these Applications are incorporated herein by reference.

### BACKGROUND

Grid-scale electrical energy storage (EES) refers to methods that store electricity on a large scale, within an electrical power grid. In brief, electrical energy is stored during times when production from power plants exceeds consumption. The stored power is used at times when consumption exceeds production. In this manner, the production of electric power can be maintained at a more constant level. Thus, fuel-based power plants (i.e. coal, oil, gas) can be more efficiently and easily operated. Moreover, there is more predictability, and greater flexibility, regarding the effect of grid-connected “intermittent energy sources”, such as solar (photovoltaics) and wind turbines. Thus, grid-scale EES is an important aspect related to the use of renewable energy sources. However, EES technologies that are currently available often operate at high cost, and/or are not truly scalable.

Redox (oxidation reduction) flow batteries (RFB's) are considered to be strong candidates for EES, due to their ability to separate power and energy, their flexible layout, and their potentially low cost. However, the low energy density (20-50 Wh/kg) and high material cost of currently-used electrode materials (e.g., vanadium or bromine) inhibit the widespread penetration of RFB's into the market. With the exception of an expensive all-vanadium device, most other RFB chemistries include catholyte-anolyte systems that may be susceptible to cross-contamination. The contamination cannot be prevented by the use of ion exchange membranes, and thus become a major problem that can require reprocessing of active materials. Additional processing steps like this can increase maintenance cost and downtime, and decrease the life of the RFB's devices. In general, there is considerable interest in reducing or eliminating two primary drawbacks in EES technologies like those that use RFB's: low energy density and high material cost.

Another important use for energy storage devices like flow batteries is the electrical vehicle (EV). The use of impractically heavy lead acid batteries has been abandoned for modern EV's. While highly advanced battery chemistries like lithium ion have shown great promise for use in modern EV's, serious drawbacks remain. For example, the battery systems still usually represent the most expensive, and heaviest component in the EV. Moreover, safety considerations sometimes require metal or “armor” plating around battery systems. The plating can add additional weight to the EV. This can, in turn, place greater demands on the battery; and can lower the operational time before recharging is necessary. Unlike lithium ion and other types of battery systems, flow batteries can conveniently separate cathode and anode components in a physical sense, and this may decrease the danger that can arise when a battery's electrode components are located next to each other.

It should be apparent from the considerations noted above that new types of flow batteries and components within the batteries would be welcome in the art. For example, flow batteries having the potential for increased energy density would represent a considerable advance for a variety of end uses. In conjunction with the flexibility allowed by the flow battery design (e.g., selective locations for the cathode and anode), relatively low costs in the battery's chemical components would represent another desirable attribute. Moreover, new types of electrodes (e.g., the cathode) that form part of the battery might very well be useful for other electrochemical applications and related systems, such as fuel cells and sensors.

### BRIEF DESCRIPTION

One embodiment of the invention is directed to a flow battery (sometimes referred to as a “flow-assisted battery”), comprising: a first chamber (catholyte) comprising an aqueous solution of at least one salt of a halogen oxoacid compound; a second chamber (anolyte) comprising an aqeuous solution of an eletrochemically-active material that is capable of participating in a reduction-oxidation (redox) reaction with the salt of the halogen oxoacid compound; at least one ion-permeable membrane separating the first chamber and the second chamber; and means for flowing the aqueous solutions through the battery.

Another embodiment is directed to a cathode capable of operating in an electrochemical reaction. The cathode comprises an aqueous solution of at least one salt of a halogen oxoacid.

Another embodiment is directed to a method of providing electrical energy to a device, system, or vehicle. The method comprises the step of electrically connecting at least one flow battery, as described herein, to the device, system, or vehicle.

Additional aspects and/or advantages of the inventive embodiments will be set forth in the description which follows.

### BRIEF DESCRIPTION OF THE DRAWINGS

FIG. 1 is a simplified schematic of a flow battery according to one aspect of the present invention.

FIG. 2 is a simplified schematic of a flow battery according to another aspect of the invention.

### DETAILED DESCRIPTION

One embodiment of the invention is directed to a flow battery that contains at least one electrochemical cell. One or more of the electrochemical cells comprise a halogen oxoacid salt, and an anode. The anode may comprise a liquid organic hydrogen carrier, or a metal. Usually, the oxoacid compound conforms to the general formula HXO₃, where X is chlorine, bromine, or iodine. The corresponding salts are the chlorate salt, the bromate salt, and the iodate salt, respectively.

In the case of chlorine, the corresponding salt of chloric acid (i.e, the chlorate) is often selected from the group consisting of sodium chlorate, potassium chlorate, lithium chlorate, calcium chlorate, magnesium chlorate, zinc chlorate; and combinations thereof. In the case of bromine, the corresponding salt of bromic acid (i.e., the bromate) is often selected from the group consisting of sodium bromate, potassium bromate, lithium bromate, calcium bromate, magnesium bromate, zinc chlorate; and combinations thereof. In the case of iodine, the corresponding salt (i.e., the iodate) is often selected from the group consisting of potassium iodate, sodium iodate, or combinations thereof.

The cathode and the anode usually comprise a catholyte and an anolyte, respectively, separated by an ion-permeable membrane. The systems also usually include current collectors and a casing. Catholyte and anolyte storage tanks are usually arranged in communication (e.g., liquid communication) with the cathode and the anode. Additional components include pumps, as well as tubing and control equipment.

The cathode chemistry is based on a reversible redox (reduction-oxidation) reaction that converts oxohalogenate ions (XO₃⁻) to halogenide ions (X⁻), wherein X can be Cl, Br, or I. In the case of chlorine, the standard half-cell potential E⁰ of this reaction is 1.45 V; and for bromine, it is 1.42V; while for iodine, it is 1.085V. This reaction allows for transfer of six electrons per halogen atom, which in combination with the high solubility exhibited by metal halates and halides, can provide a relatively high energy density for a cathode—especially in the case of the chlorates/chlorides. (For the sake of simplicity, chlorine is often used for illustration. However, it should be understood that bromine or iodine could be alternatively used. In some cases, the term “halate” will be used to describe any of the chlorates, bromates, or iodates). Thus, in the case of chlorine, the catholyte usually comprises metal chlorates in the charged form, and metal chlorides in the discharged form.

According to embodiments of this invention, discussed below, the anolyte for the cell comprises an organic hydrogen carrier (usually in liquid form), capable of reversible dehydrogenation, and optionally a solvent and a salt. The dehydrogenation reaction can result in the formation of a stable dehydrogenated compound, or a mixture of hydrogenated and dehydrogenated forms of a compound.

As alluded to previously, the cathode chemistry is based on a reversible redox reaction that involves the conversion of the halate to the corresponding halide ion. Upon discharge, the halate ion (e.g., chlorate) consumes six electrons and six protons to generate a halide ion (e.g., chloride) and three water molecules. During charging of the cell, the reaction proceeds in the reverse direction (E⁰=1.45 V, in the chase of chlorate/chloride).

(ClO₃)⁻+6 H⁺+6e⁻<==>Cl⁻+3 H₂O (Equation 1)

The oxidation of Cl— to ClO₃⁻ ions is known in the art, and is currently used in industrial processes, e.g, in the production of NaClO₃. Sodium chlorate is produced in undivided electrolytic cells, starting from NaCl brine. At a controlled pH (in some cases, between 6 and 7, and more particularly between about 6.3 and 6.6), the anodic reaction produces ClO⁻ and HClO, which can rapidly disproportionate at the process temperatures (60-90° C.) to NaClO₃ and NaCl, while hydrogen (H₂) evolves at the cathode side.

In addition to disproportionation, the halate, such chlorate, is also generated by direct electrochemical means. Transition metal salts may be used to suppress the anodic O₂ evolution and, and reduce over-potential. The electrochemical reduction of chlorate to chloride ions is known in the art, and can be catalyzed by cobalt salts. In general, the chemical reaction occurring at the anode for this type of cell is a reversible dehydrogenation of an organic hydrogen carrier, according to the following equation:

LHₙ<==>L+n H⁺+n e⁻ (Equation 2),

wherein L is an organic compound containing one or more unsaturated bonds, e.g., C═C, C═O, C═N, C≡N; or one or more aromatic rings.

As mentioned previously, at least one organic hydrogen carrier is used for embodiments of this invention. In some embodiments, the organic hydrogen carrier is one that is capable of producing aromatic compounds or carbonyl compounds upon dehydrogenation. Some examples of suitable organic hydrogen carriers are cyclic hydrocarbons, heterocyclic compounds; alcohols, and combinations thereof. Non-limiting examples of the alcohols are 2-propanol, 1,3,5-trihydroxy cyclohexane; 2,3-butanediol; 1,4-butanediol; 1,4-pentanediol; 1,5-pentanediol; and combinations thereof. A low-melting mixture of two or more carriers can be used. A solvent and a salt can be added for improved conductivity.

An electrocatalyst is usually needed to reduce the over-potential for electrochemical dehydrogenation and hydrogenation of organic carriers. The electrocatalyst can be deposited on a porous conductive material in combination with an ionomer to form a liquid diffusion layer. Non-limiting examples of electrocatalysts that are suitable for embodiments of this invention are polyoxometalate-based materials; platinum, palladium, nickel, and various alloys of these metals.

The overall cell reaction for most embodiments (again, using chlorine as the illustration) can be described as in Equation 3:

M(ClO₃)ₘ+LHₙ<==>L+MClₘ+H₂O (Equation 3),

wherein “M” is usually at least one of Li, Na, Ca, or Zn.

Depending in part on the identity of the organic hydrogen carrier, the standard open circuit potential of the proposed flow battery will be in the range about 1.25-1.40 V. Metal chlorates (as well as the iodates and bromates) are usually highly soluble. An especially energy-dense species is the cathode based on an aqueous solution of LiClO₃. In other instances, Ca(ClO₃)₂ or NaClO₃ may be suitable alternatives, due in part to their lower cost.

The control of pH is an essential factor in maintaining high efficiency, due to the selective chlorate formation and the prevention of anode dissolution. In some embodiments, the optimal pH of the halate catholyte may be supported by the addition of a buffer to the anolyte. The reaction set out as Equation 3 does not alter the pH, and maintenance of the catholyte pH can be readily accomplished. Moreover, the use of selected ion-permeable membranes should prevent or minimize crossover of fuel and oxidant, to minimize side reactions and efficiency loss.

In some embodiments, the buffer comprises a mixture of a weak acid and its conjugate base. A number of suitable conjugate bases may be used. Examples include an acetate anion, a citrate anion, a succinate anion, a dihydrophosphate anion, N-Cyclohexyl-2-aminoethanesulfate anion, a borate anion, ammonia, trialkylamines of general formula NR₃, where R is an alkyl group that usually contains about 1-4 carbon atoms; tris(hydroxymethyl)methylamine, N,N-bis(2-hydroxyethyl)glycine; and combinations thereof.

The use of a flow battery having a halate cathode—sometimes in conjunction with an electro-deposited metal anode as described below—provides at least several advantages. For example, the overall energy density of the system can be substantially increased, as compared to conventional flow battery systems, due in part to the very high solubility of the active materials. The higher energy density can in turn increase the economic viability of the system. The overall electrochemical process can be initiated with metal halides (e.g., chlorides) in the discharged battery state. In some cases, the relatively low cost of the active materials described herein will further enhance the economics of the system. Moreover, the use of an organic hydrogen carrier provides additional advantages noted herein.

The use of a halate cathode such as one based on the chlorate may also result in less safety issues, as compared to the use of other energy-dense cathodes, e.g. bromine. Active materials are dissolved in water, and the fact that no heavy metals are usually employed will also be beneficial from an environmental perspective.

In general, liquid cathodes usually resist degradation, and can therefore experience a relatively long service life. Moreover, since the anolyte and the catholyte in some embodiments contain essentially the same materials, cross-contamination within the cell should generally not occur, although a relatively small energy loss could occur if the halate or halide ions cross over the membrane-separator. In some embodiments, reversible flow batteries that use a calcium chlorate cathode may be selected, when low cost and energy density represent the primary objectives.

In general, aqueous solutions of the halates of various metals (e.g., sodium, lithium, calcium, zinc, nickel, or copper) may be used as the cathodes. The energy density of the cathode is usually determined by the solubility of the metal halate and the metal halide salts.

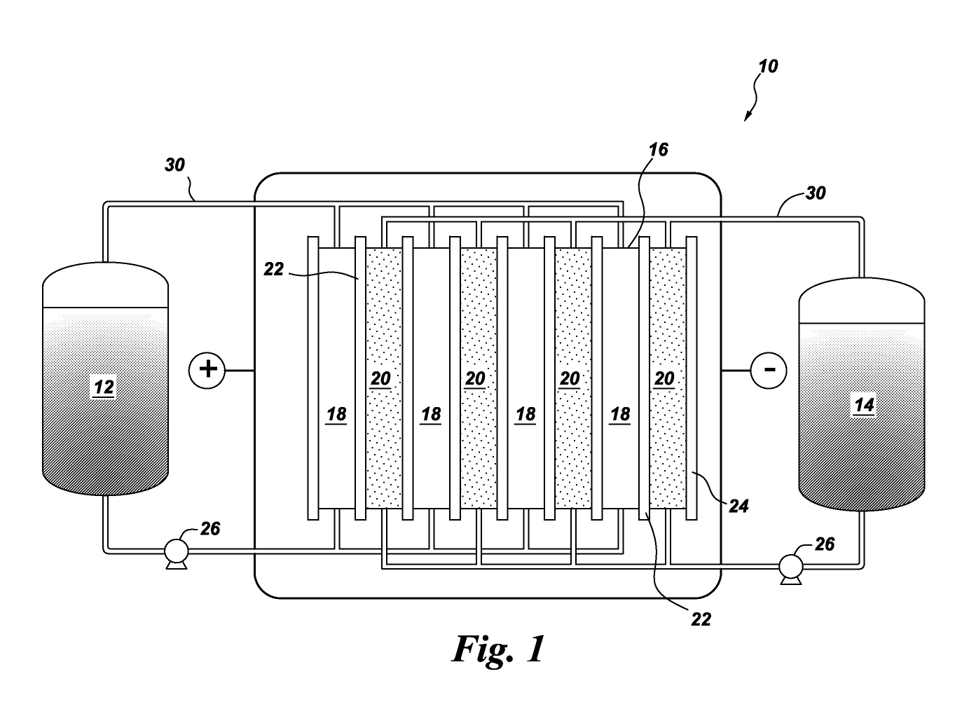

FIG. 1 is a schematic of a flow-assisted battery 10 according to some embodiments of this invention. The catholyte 12 usually comprises a solution of at least one chloride salt, e.g., zinc chlorate or copper chlorate, when the battery is in the charged state. The anolyte 14 usually comprises a zinc or copper salt. The anolyte can optionally include a buffer. As alluded to below, zinc can be present within the anolyte of the flow battery, in the form of a slurry or a fine powder or sheet of material that detaches from the surface of the anode.

The central structure 16 of the battery, i.e., a bipolar cell stack, includes a series of alternating positive plates 18 and negative plates 20, separated by ion-permeable membranes 22. Each of the positive and negative electrodes may include an electrically-conductive substrate, such as carbon (in a conductive form), or a metal.

As alluded to previously, the ion-permeable membrane is used to separate the anolyte and the catholyte, and in most cases, to provide proton transport. A number of different types of membranes can be used. One example is a proton exchange membrane, often incorporated into proton exchange membrane (PEM) fuel cells. A number of materials can be used for such a membrane; and they are generally well-known in the art. Examples for many embodiments are the sulfonated fluoropolymer-copolymers, e.g., Nafion® -type materials. These types of membranes are oxidatively stable, and are often relied upon by the chlor-alkali industry.

In operation, the anolyte regions of the cell would be formed of a metal or metal alloy in the charged state. The metal/metal alloy is capable of being dissolved into a salt, during a redox reaction, e.g., a metal chloride. On the catholyte side, a metal chlorate is converted to the corresponding metal chloride during the discharge. The reactions are reversed during the charging cycle. Thus, for some embodiments of this invention, the chlorate species is being converted to a chloride ion upon discharge, while the chloride-to-chlorate reaction occurs during charging. On the anode side, metal ions are converted to the respective metal itself during charging; while the metal is dissolved into a corresponding salt, such as the chloride salt, during discharge.

Those skilled in the art understand that the battery 10 may include various other features and devices as well. As mentioned above, non-limiting examples include current collectors (not specifically shown), and additional electrodes. (Thus, an electrode and a separate catholyte storage tank can be associated with the catholyte chamber; while another electrode and a separate anolyte storage tank can be associated with the anolyte chamber). Other features of the flow battery system may include pumps 26, for circulating the catholyte and anolyte solutions through system 10, via tubes/conduits 30. Conventional pumps can be used. Other methods for circulating the solutions are also possible, e.g., gravity-based systems. A number of references describe various features of flow batteries, e.g., U.S. Patent Application 2014/0132238 (Zaffou et al), incorporated herein by reference. Moreover, in some embodiments, the flow battery can be designed as a plurality of single batteries (electrochemical cells), having common anolyte and catholyte storage tanks.

Other examples of features and devices for the battery include sensors for pressure measurement and control; and for gas flow; temperature; and the like. Battery systems of this type will also include associated electrical circuitry and devices, e.g, an external power supply; as well as terminals for delivering battery output when necessary. Other general considerations regarding flow batteries can be found in a number of references, e.g,. “Zinc Morphology in Zinc-Nickel Flow Assisted Batteries and Impact on Performance”; Y. Ito et al; Journal of Power Sources 196 (2011) 2340-2345.

In some specific embodiments, electrochemical activity at the anode is carried out as a reversible electrodeposition/dissolution of a metal (“M”) selected from the a group of Zn, Cu, Ni, Sn, Bi, Sb and described by Equation 2, noted below:

M<==>M⁽ⁿ⁺⁾+n e⁻ (Equation 4)

Theoretical open circuit potentials for cells with anodes made of zinc, nickel, copper, and tin are 2.21, 1.71, 1.11 and 1.59 V, respectively.

When a metal is plated as a uniform deposit on the anode, the kinetic reactions may be relatively rapid. However, the cell capacity may be limited, e.g, by the thickness of the metal layer; and the process thereby requires accurate control. When the plated metal forms a powder detached from the anode, the battery capacity is limited by the practical content of metal particles in the circulating slurry. The approach for embodiments of the present invention broadens the range of process conditions, including pH, which simplifies the task of coupling anodic and cathodic reactions. However, the handling (e.g., pumping) of a slurry composition is required. The overall cell reaction can be expressed by Equation 5, where “M” is zinc or another one of the metals described herein.

M(ClO₃)₂+6 M+12 HCl<==>7 MCl₂+6 H₂O (Equation 5)

Due to the high solubility of metal chlorates and chlorides, it is possible to use the same metal cation in both the anode and cathode. The control of pH is often an important factor in maintaining high efficiency, by promoting selective chlorate formation, and preventing or minimizing anode dissolution. The MCl₂ reduction to metal is accompanied by the formation of 2 moles HCl, and some metals, such as zinc (Zn), may not be stable in acids. This problem can be mitigated by driving the electrochemical process in the presence of a buffer. In one embodiment, the buffer may comprise NH₄Cl. Upon charging of the battery, ammonia present in the form of soluble (Zn(NH₃)₄)²⁺ will absorb HCl to form soluble NH₄Cl, as expressed in Equation 6, thereby maintaining a desirable pH.

Zn(ClO₃)₂+6 Zn+12 NH₄Cl<==>3 Zn(NH₃)₄Cl₂+4 ZnCl₂+6 H₂O (Equation 6)

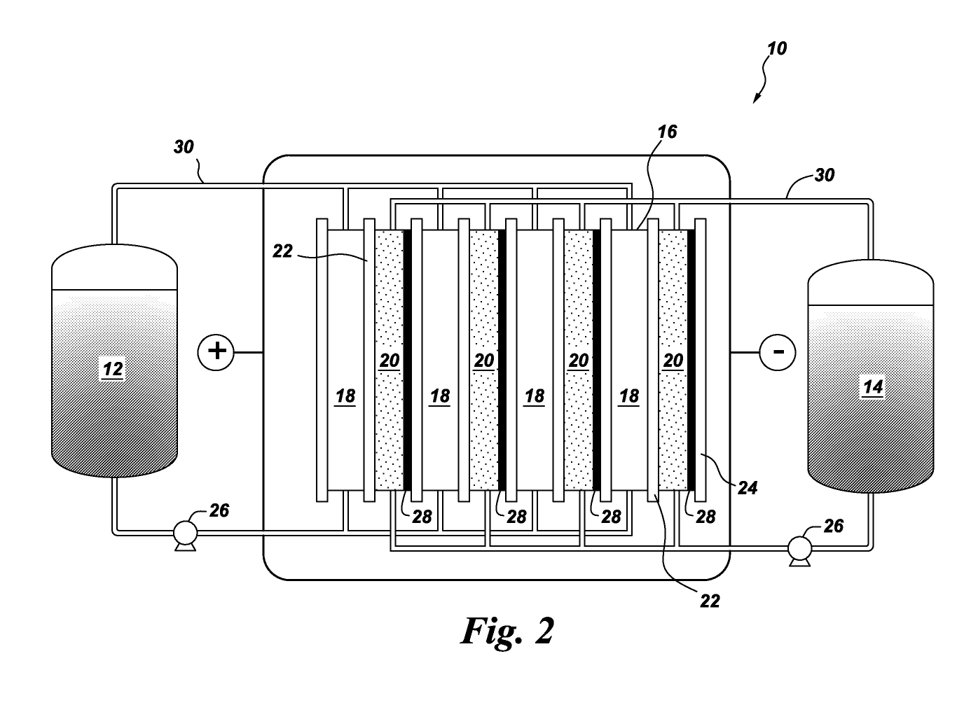

FIG. 2 is a schematic of a flow-assisted battery 10 that demonstrates these principles. Reference numerals common to the system of FIG. 1 represent similar or identical elements. Again, the catholyte 12 usually comprises a solution of at least one halide salt, e.g., zinc chlorate, when the battery is in the charged state. The anolyte 14 in this embodiment usually comprises a zinc salt, but can also take the form of a buffering compound, e.g., an ionic buffer like an ammonia compound, or a phosphate. As in the embodiment of FIG. 1, the central structure of the battery, i.e., a bipolar cell stack, includes a series of alternating positive plates 18 and negative plates 20, separated by ion exchange membranes 22. Each of the positive and negative electrodes may include an electrically-conductive substrate, such as carbon (in a conductive form), or a metal.

In this embodiment, the anolyte regions of the cell would include a plated zinc deposit 28, in the charged state, which is then dissolved into a salt, such as zinc chloride. On the catholyte side, zinc chlorate (or another zinc halate) is converted to the corresonding chloride (e.g., zinc chloride) during the discharge. The reactions are reversed during the charging cycle. Thus, for some embodiments of this invention, the chlorate species is being converted to a chloride ion upon discharge, while the chloride-to-chlorate reaction occurs during charging. On the anode side, Zn ions are converted to zinc metal (or another metal respectively) during charging; while the zinc metal is dissolved into a zinc salt, such as the chloride salt, during discharge. Significant advantages for these types of cells, containing the zinc-deposited anode, arise from the relatively high electrical potential and solubility of the zinc material; and this will desirably result in relatively high energy density.

As mentioned above, the flow batteries of embodiments of the present invention can be used as part of an electrical grid system, i.e., an interconnected network for delivering electricity from suppliers to consumers. For example, multiple flow batteries (often, a large number) can be interconnected by known techniques, to allow storage of electricity on a large scale within the power grid. Those involved with electrical power generation on a commercial scale are familiar with various other features of the grid, e.g,. power generation stations, transmission lines, and at least one type of power control and distribution apparatus. The flow batteries described herein may be able to provide the increased energy density, along with lower battery costs, which would make them an attractive alternative for (or addition to) other types of grid storage units or systems.

The flow batteries described herein can also be used for electrical vehicles, trucks, ships, and trains, as well as for other applications, such as submarines and airplanes. EVs include electric cars and hybrid electric cars. The flow batteries could be incorporated as part of an electric powertrain, alone or supporting an internal combustion system. The flow batteries could also be used as independent electric source for the vehicle, e.g., for lighting, audio, air conditioning, windows, and the like.

Those skilled in the art are familiar with battery pack designs suitable for a given type of EV; as well as techniques for incorporating the battery into the drivetrain or other systems of the vehicle. As alluded to previously, the flexibility of the flow battery, including the ability to locate catholyte and anolyte sources in different parts of the vehicle, may represent a considerable design advantage. The benefits of increased energy density arising from use of the halogen oxoacid salts can also enhance the battery profile of the electric vehicle or other device.

Another embodiment of this invention is directed to a cathode based on a halogen oxoacid salt, as described above. The cathode could be used for other types of electrochemical devices , i.e., in addition to its use in batteries. Non-limiting examples include fuel cells and sensors. An illustration of an electrochemical sensor that might be enhanced by this inventive embodiment can be found in U.S. Pat. No. 8,608,923 (Zhou et al), “Handheld Electrochemical Sensor”, which is incorporated herein by reference. Various types of fuel cells might also incorporate the cathode described herein, e.g., proton exchange membrane fuel cells and alkaline fuel cells.

Yet another embodiment is directed to a method of providing electrical energy to a device, system (e.g., a power grid), or vehicle. The method comprises the step of electrically connecting at least one flow battery to the device or other object. The connection is configured to allow electrochemically-produced energy from the battery to selectively energize the device, or to provide additional (e.g., backup) energy to a device or system that already includes a primary energy supply. The flow battery includes the aqueous solution of at least one salt of a halogen oxoacid, as described above, along with the other battery components.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A flow battery, comprising:
a catholyte first chamber comprising an aqeuous solution of at least one salt of a halogen oxoacid;
an anolyte second chamber comprising an aqeuous solution of an electrochemically active material that is capable of participating in a reduction-oxidation reaction with the at least one salt of the halogen oxoacid;
at least one ion-permeable membrane separating the first chamber and the second chamber; and
means for flowing the aqueous solutions through the battery.

2. The battery of claim 1, wherein the halogen oxoacid has the formula HXO₃ (halate), wherein X is chlorine (Cl), bromine (Br), or iodine (I).

3. The battery of claim 2, configured to promote the reversible redox (oxidation-reduction) reaction that converts oxohalogenate ions (XO₃⁻) to halogenide ions (X⁻), wherein X is chlorine (Cl), bromine (Br), or iodine (I).

4. The battery of claim 2, wherein the halogen oxoacid is chloric acid, HClO₃, and the corresponding salt is a chlorate salt.

5. The battery of claim 4, wherein the chlorate salt is selected from the group consisting of sodium chlorate, potassium chlorate, lithium chlorate, calcium chlorate, magnesium chlorate, zinc chlorate, and combinations thereof.

6. The battery of claim 1, wherein the second chamber contains an electro-deposited metal anode.

7. The battery of claim 6, wherien the electro-deposited metal is zinc.

8. The battery of claim 1, wherien the second chamber further includes a buffer that comprises a mixture of a weak acid and its conjugate base.

9. The battery of claim 8, wherien the conjugate base is selected from the group consisting of an acetate anion, a citrate anion, a succinate anion, a dihydrophosphate anion, N-Cyclohexyl-2-aminoethanesulfate anion, a borate anion, ammonia, trialkylamines of general formula NR₃, where R is an alkyl group that contains about 1-4 carbon atoms; tris(hydroxymethyl)methylamine, N,N-bis(2-hydroxyethyl)glycine; and combinations thereof.

10. The battery of claim 1, wherein the ion-permeable membrane comprises a proton exchange membrane.

11. The battery of claim 10, wherien the proton exchange membrane comprises a sulfonated fluoropolymer-copolymer.

12. The battery of claim 1, wherein the second chamber further comprises an organic hydrogen carrier.

13. The battery of claim 12, wherein the organic hydrogen carrier is capable of producing aromatic compounds or carbonyl compounds upon dehydrogenation.

14. The battery of claim 13, wherein the organic hydrogen carrier is selected from the group consisting of cyclic hydrocarbons, heterocyclic compounds; alcohols, and combinations thereof.

15. The battery of claim 1, wherein the flow battery includes a bipolar cell stack that comprises a series of electrically-conductive bipolar electrode plates, each separated by one of the ion-permeable membranes.

16. The battery of claim 15, wherein a material providing the electrically-conductive characteristic of the plates is a metal or a conductive form of carbon.

17. A cathode capable of operating in an electrochemical reaction, comprising: an aqueous solution of at least one salt of a halogen oxoacid, having the formula HXO₃ (halate), wherein X is chlorine (Cl), bromine (Br), or iodine (I).

18. The cathode of claim 17, incorporated into at least one electrochemical device selected from the group consisting of batteries, fuel cells, and sensors.

19. An electric vehicle or an electric grid system that includes at least one flow battery comprising:
a catholyte first chamber comprising an aqeuous solution of at least one salt of a halogen oxoacid;
an anolyte second chamber comprising an aqeuous solution of an electrochemically active material that is capable of participating in a reduction-oxidation reaction with the at least one salt of the halogen oxoacid;
at least one ion-permeable membrane separating the first chamber and the second chamber; and
means for flowing the aqueous solutions through the battery.

20. A method of providing electrical energy to a device, system, or vehicle, comprising the step of electrically connecting at least one flow battery to the device, system, or vehicle, so as to allow electrochemically-produced energy from the battery to selectively energize the device, system, or vehicle, wherien the flow battery comprises:
a first chamber (catholyte) comprising an aqeuous solution of at least one salt of a halogen oxoacid;
a second chamber (anolyte) comprising an aqeuous solution of an electrochemically active material that is capable of participating in a reduction-oxidation (redox) reaction with the salt of a component;
at least one ion-permeable membrane separating the first chamber and the second chamber; and
means for flowing the aqueous solutions through the battery.
